(19) United States
(12) Patent Application Publication
(10) Pub. No.: US 2007/0162890 A1
(43) Pub. Date: Jul. 12, 2007

(54) SECURITY ENGINEERING AND THE APPLICATION LIFE CYCLE

(75) Inventors: John D. Meier, Bellevue, WA (US); Srinath Vasireddy, Issaquah, WA (US); Michael Dunner, Renton, WA (US); Blaine Wastell, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/382,858

(22) Filed: May 11, 2006

Related U.S. Application Data
(63) Continuation-in-part of application No. 11/321,425, filed on Dec. 29, 2005.

(51) Int. Cl. G06F 9/44

(52) U.S. Cl. 717/100

(57) ABSTRACT

A novel approach to security engineering that leverages expertise to enable a user to design, build and deploy secure applications is disclosed. In doing so, the innovation discloses novel techniques and mechanisms that integrate security into the application development lifecycle and to adapt current software engineering practices and methodologies to include specific security related activities. These activities include identifying security objectives, creating threat models, applying secure design guidelines, patterns and principles, conducting security design inspections, performing regular code inspections, testing for security, and conducting deployment inspections to ensure secure configuration.

### CROSS-REFERENCE TO RELATED APPLICATIONS

This application is a Continuation-in-Part of pending U.S. patent application Ser. No. 11/321,425 entitled “SECURITY MODELING AND THE APPLICATION LIFE CYCLE” and filed Dec. 29, 2005. Additionally, this application is related to pending U.S. patent application Ser. No. 11/321,153 entitled “INFORMATION MODELS AND THE APPLICATION LIFE CYCLE” filed on Dec. 29, 2005, Ser. No. 11/321,818 entitled “PERFORMANCE MODELING AND THE APPLICATION LIFE CYCLE” filed on Dec. 29, 2005, Ser. No. 11/353,821 entitled “WEB APPLICATION SECURITY FRAME” filed on Feb. 14, 2006, and Ser. No. 11/363,142 entitled “SERVER SECURITY SCHEMA” filed on Feb. 27, 2006. The entireties of the above-noted applications are incorporated by reference herein.

### BACKGROUND

Analysis of software systems with respect to security and performance has proven to be extremely useful to development requirements and to the design of systems. As such, it can be particularly advantageous to incorporate security engineering and analysis into the software development life cycle from the beginning stages of design. Conventionally, the application life cycle lacks security engineering and analysis thereby prompting retroactive measures to address identified security attacks and issues.

Today, when developing an application, it is oftentimes difficult to predict how the application will react under real-world conditions. In other words, it is difficult to predict security vulnerabilities of an application prior to and during development and/or before completion. Frequently, upon completion, a developer will have to modify the application in order to adhere to real-world conditions and threats of attacks. This modification can consume many hours of programming time and delay application deployment—each of which is very expensive.

Traditionally, designing for application security is oftentimes random and does not produce effective results. As a result, applications and data associated therewith are left vulnerable to threats and uninvited attacks. In most cases, the typical software practitioner lacks the expertise to effectively predict vulnerabilities and associated attacks.

While many threats and attacks can be estimated with some crude level of certainty, others cannot. For those security criterions that can be estimated prior to development, this estimate most often requires a great amount of research and guesswork in order to most accurately determine the criterion. The conventional guesswork approach of security analysis is not based upon any founded benchmark. As well, these conventional approaches are not effective or systematic in any way.

Rather, conventional security approaches are based upon a trial-and-error mechanism. In other words, traditional systems tend to be reactive as users lack the expertise necessary to formulate a proactive security mechanism. As such, these traditional trial-and-error approaches lead to costly interruptions and expensive programming time in order to rectify issues as they arise.

In summary, traditional application life cycle development approaches do not proactively (and accurately) address security issues from the beginning to the end of the life cycle. To the contrary, developers often find themselves addressing security and performance issues after the fact—after development is complete. This retroactive modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a novel approach to security engineering that leverages expertise to enable a user to design, build and deploy secure applications. In doing so, the innovation discloses novel techniques and mechanisms to integrate security into the application development lifecycle and to adapt current software engineering practices and methodologies to include specific security related activities. In one aspect, these activities include identifying security objectives, creating threat models, applying secure design guidelines, patterns and principles, conducting security design inspections, performing regular security code inspections, testing for security, and conducting security deployment inspections to ensure secure configuration.

The innovation enables security to be baked into the application lifecycle. In order to be effective, upfront security design performed against a defined set of security objectives is often required. The subject innovation discloses novel features, techniques, mechanisms and activities for upfront security design. Security objectives can also be balanced against other quality of service attributes such as performance, availability and flexibility requirements and other business objectives such as time to market.

In accordance with the innovation, the security related activities start early and should continue throughout the lifecycle, many in parallel with one another. The security objectives should be considered alongside other critical business objectives. Application specific security objectives should be identified and documented early during requirements and analysis and should be balanced along side other quality of service requirements such as performance, availability and reliability.

In operation, the security objectives can assist to prioritize and focus threat modeling activity to identify threats and vulnerabilities. The identified vulnerabilities should be used to shape and influence subsequent design and development decisions. They can also be used by test teams to scope testing and to define specific test cases to ensure that specific vulnerabilities have either been eliminated or suitably addressed.

As well, code inspections for security can be an ongoing activity within the development phase. Testing can start early and be driven in part by the vulnerabilities identified during the threat modeling activity.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that integrates security engineering into the application development life cycle in accordance with an aspect of the innovation.

FIG. 2 illustrates an exemplary flow chart of procedures associated with a novel security approach in accordance with an aspect of the innovation.

FIG. 3 illustrates an exemplary list of security engineering activity components in accordance with the novel subject matter of the innovation.

FIG. 4 illustrates an exemplary timeline with respect to exemplary security activities in accordance with an application life cycle.

FIG. 5 illustrates a system that employs a security objective identification component with respect to security engineering components in accordance with an aspect of the innovation.

FIG. 6 illustrates an exemplary security objectives identification component in accordance with an aspect of the innovation.

FIG. 7 illustrates a system that employs a novel security frame component to interface with specific security engineering activities in accordance with an aspect of the innovation.

FIG. 8 illustrates an exemplary flow chart of procedures associated with a threat modeling activity in accordance with an aspect of the innovation.

FIG. 9 illustrates an application review process in accordance with an aspect of the innovation.

FIG. 10 illustrates an exemplary flow chart of code inspection procedures in accordance with an aspect of the innovation.

FIG. 11 illustrates an exemplary set of security deployment categories in accordance with an aspect of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The following terms are used throughout the description, the definitions of which are provided herein to assist in understanding various aspects of the subject innovation.

A “Threat” is an undesired event. A potential occurrence, often best described as an effect that might damage or compromise an asset or objective. It may or may not be malicious in nature.

A “Vulnerability” is a weakness in some aspect or feature of a system that makes an exploit possible. Vulnerabilities can exist at the network, host, or application levels and include operational practices.

An “Attack” is an action taken that uses one or more vulnerabilities to realize a threat. This could be someone following through on a threat or exploiting a vulnerability.

A “Countermeasure” addresses vulnerabilities to reduce the probability of attacks or the impacts of threats. Countermeasures do not directly address threats; instead, they address the factors that define the threats Countermeasures range from improving application design or improving code, to improving an operational practice.

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

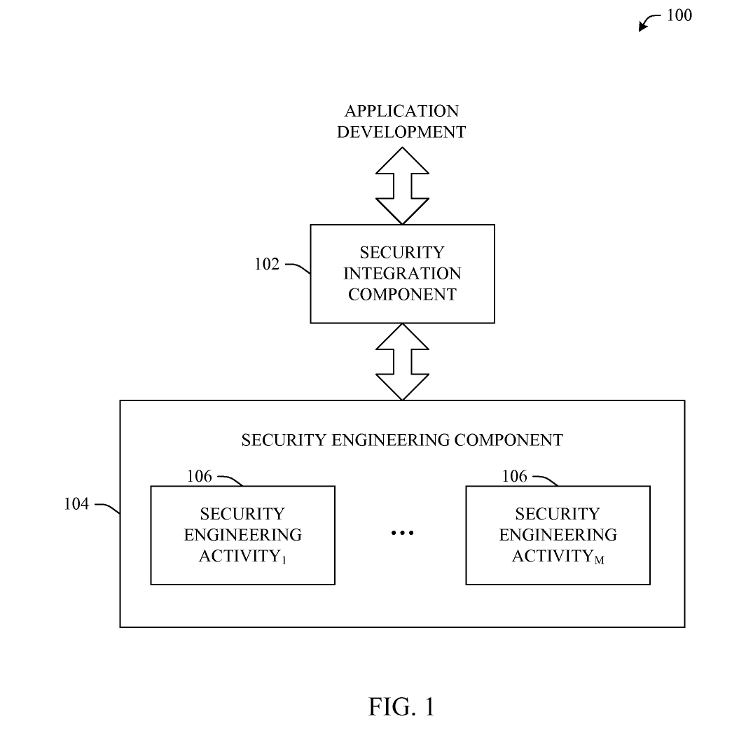

Referring initially to the drawings, FIG. 1 illustrates a system 100 that facilitates predictably and systematically meeting security objectives thereby reducing risk in accordance with an aspect of the innovation. Generally, the system 100 can include a security integration component 102 and a security engineering component 104 having 1 to M security engineering activities therein. The 1 to M security engineering activities can be referred to individually or collectively as security engineering activities 106.

In one particular aspect, the security engineering component 104 can include specific security related activities 106. By way of example, the activities 106 can include identifying security objectives, creating threat models, applying secure design guidelines (e.g., patterns and principles), conducting security design inspections, performing regular security code inspections, security testing, and conducting security deployment inspections to ensure secure configuration. Each of these security engineering activities will be described in greater detail with reference to the figures that follow.

In general, the innovation discloses a novel patterns & practices approach to security engineering. To design, build, and deploy secure applications, a developer can employ the security integration component 102 to incorporate security into the application development life cycle by including specific security-related activities (e.g., 106) in the current software engineering processes. As stated above, the security-related activities 106 can include identifying security objectives; applying security design guidelines, patterns, and principles; conducting security architecture and design inspections; creating threat models; performing security code inspections; security testing; and conducting security deployment inspections. The developer or user can adopt these activities 106 incrementally as desired. The combination of these activities 106 can provide tools, guidance, and workflow to help make security a seamless part of the development experience.

In accordance with aspects of the innovation, security objectives and requirements can be defined early in the development process. Security objectives can be goals and constraints around the confidentiality, integrity, and availability of the data and application. Threat modeling facilitates understanding and prioritization of the threats relevant to a specific application scenario. The innovation discloses proven practices, patterns and principles that can assist in avoiding many possible vulnerabilities introduced by poor design choices. By organizing these design patterns and practices into novel like vulnerability categories, the user can focus on those key areas where security mistakes are most often made.

In another aspect, the innovation discloses an architecture and security design inspection process that analyzes the application architecture and design from a security perspective. By way of example, the innovation considers a number of aspects including deployment and infrastructure, application architecture and design and a tier by tier analysis.

All code should be subject to code inspections where the emphasis is on spotting security vulnerabilities. This should be a continual activity during the development phase of the lifecycle. With respect to security testing, a risk-based approach can be employed. As well, the output from the threat modeling activity can be used to help scope the testing activities and to define test plans. When the application is deployed, it is particularly important to be sure that weak or inappropriate configuration settings do not introduce security vulnerabilities. By using these specific activities for security engineering, the user can leverage expertise into the application life cycle by knowing where to start, how to proceed, and when the process is complete.

As illustrated in FIG. 1, and the figures that follow, in summary, this innovation describes an approach for integrating security into the software development life cycle. It describes the set of security activities 106 that could be employed to refine and extend existing life cycle activities. In all, the innovation presents an overview of the approach and explains some of the main security engineering activities as well as how to adopt them.

The system 100 can provide the following novel features. The system 100 can provide end-to-end guidance on building software that meets specified and/or defined security objectives, throughout the application life cycle, to reduce risk and increase return on software development costs. As will be described in further detail infra, the guidance can use a novel security frame which is a pattern based information model that defines a set of security-related categories specifically for the application type being designed. These categories can represent the areas where security mistakes are most often made. The novel patterns & practices security guidance of the innovation includes context-specific security frames for each major application type (e.g., web application).

The novel principles & practices mechanisms of the innovation serve as a foundation for security guidance and provide a stable basis for security-related recommendations. With respect to processes and activities, the guidance provides steps for key activities including threat modeling, security architecture and design inspections, security code inspections and security deployment inspections. For simplification and tangible results the life cycle can be decomposed into activities with inputs, outputs, and steps. The steps can be used as a baseline or to help evolve other specific activities. Although numerous activities are described herein it is to be understood that each module or activity within the guidance is designed to be read independently.

In summary, the patterns & practices approach to security engineering focuses on integrating security into the life cycle through the adoption of a limited set of key security activities 106. As will be described below, the specific activities 106 that make up the security engineering discipline can include defining security objectives, applying design guidelines for security, creating threat models, conducting architecture and design inspections for security, completing code inspections for security, and performing deployment inspections for security. While these specific security activities 106 are described herein, it is to be understood that additional and/or disparate activities can be incorporated without departing from the spirit and scope of the innovation. As such, these additional security activities are to be included within the scope of this disclosure and claims appended hereto.

Turning now to a discussion of the patterns & practices approach to security engineering. To design build, and deploy secure applications a user can integrate security into the application development life cycle by including specific security-related activities into current software engineering processes. As described above security-related activities (e.g., security engineering activity 106) can include identifying security objectives; applying secure design guidelines, patterns, and principles; conducting security design inspections; creating threat models; performing regular security code inspections, testing for security; and conducting deployment inspections to ensure secure configuration. A user can adopt these activities incrementally as desired.

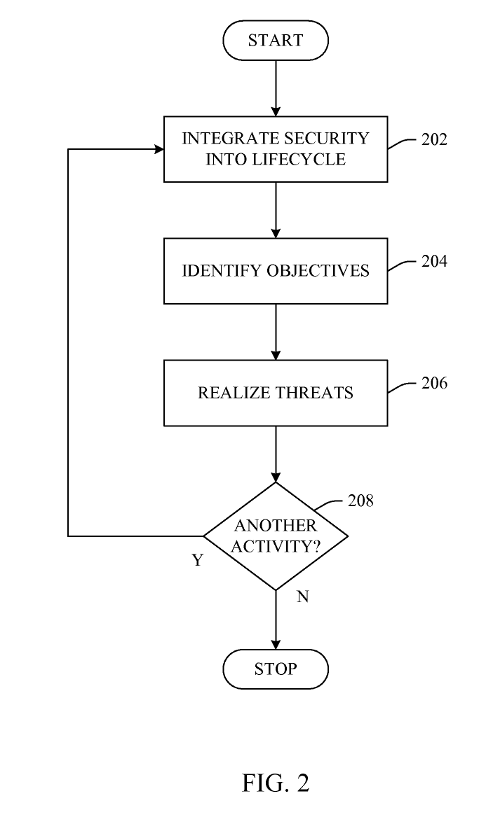

FIG. 2 illustrates a methodology of the novel security approach in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

As illustrated in FIG. 2, the patterns & practices approach to security engineering is summarized in accordance with an aspect of the innovation. At 202, security can be integrated into the life cycle. More particularly, upfront security design, secure coding practices, and testing for security can all be an integral part of the application development processes.

Objectives can be identified at 204. In doing so, an understanding can be made early with respect to the security objectives that correspond to an application. These objectives can play a critical role in shaping threat modeling, code reviews, and testing. Threats are realized at 206. In other words, at 206, analysis of the application in a structured and systematic manner can be effectuated to recognize application threats and vulnerabilities. In one example, the threats can be used in connection with a threat modeling activity that enables identification and understanding of threats, understanding of the risks each threat poses and uncovering vulnerabilities that can be used to shape subsequent security design and implementation decisions

As shown by the determination block at 208, an iterative approach can be employed to perform multiple activities. For example, some activities, such as code review threat modeling and security testing could be performed multiple times during the development process to maximize application security.

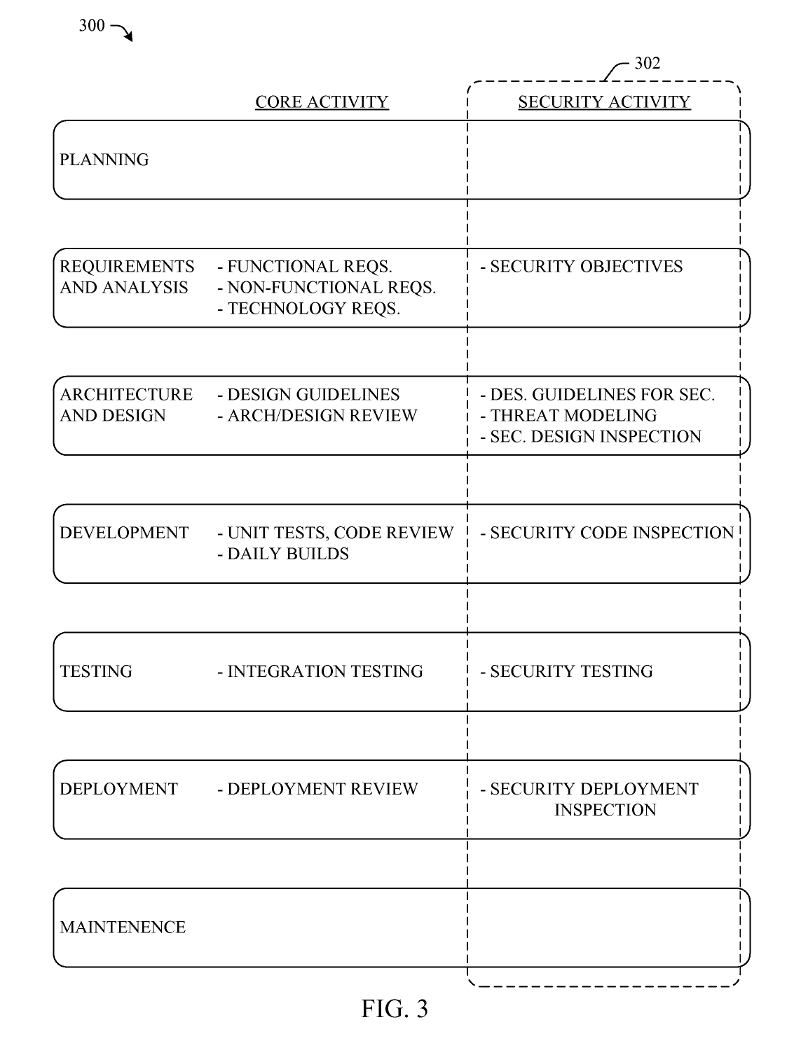

FIG. 3 illustrates an exemplary list of security engineering activity components 106 with respect to an application development life cycle. More specifically, FIG. 3 illustrates an exemplary life cycle diagram 300 that includes security activities 302 in connection with particular core application life cycle activities. Although specific activities 302 are shown in FIG. 3, it is to be understood that other activities can exist and are to be included within the scope of this disclosure and claims appended hereto.

As shown in FIG. 3, there are a number of distinct security-related activities 302 that should be an integral part of the application life cycle. More particularly, the activities can include, but are not limited to include, security objectives, design guidelines for security, threat modeling, security design inspection, security code inspection, security testing and security deployment inspection. Each of these activities is described below.

Knowledge of security objectives is essential to the success of all other security-related activities. The innovation proposes definition of security objectives and requirements early in the process. Security objectives are goals and constraints that can affect the confidentiality, integrity, and availability of the data and application.

Adopting security design guidelines can help reduce the attack surface by addressing common vulnerabilities, allowing focus on the unique aspects of the design. To avoid many of the vulnerabilities introduced by poor design choices, the design activity should use proven design practices, patterns, and principles. By organizing these design patterns and practices into common vulnerability categories, the user can focus on those areas where security mistakes are most often made.

Threat modeling is an engineering technique that can be used to help identify threats, attacks, vulnerabilities, and countermeasures that may be relevant to the application. In operation, threat modeling helps a user to understand and identify the threats and vulnerabilities relevant to a specific application scenario.

Security architecture and design inspection addresses what it is and why it should be used. This activity also describes some of the key concepts behind the approach. The architecture and security design inspection process analyzes the architecture and design from a security perspective. It examines a number of aspects including deployment and infrastructure, overall application architecture and design, and each tier in the application.

Security code inspection is an effective mechanism for uncovering security issues before testing or deployment begins. Performing security code inspections helps reduction of the number of implementation errors in an application before it is deployed to a test team or to a customer. All code should be subject to code inspections where the emphasis is on identifying security vulnerabilities. This should be a continuous activity during the development and test phases of the application life cycle.

Security testing uses a risk-based approach and uses the output from the threat modeling activity to help establish the scope of testing activities and definition of test plans. Finally, a security deployment inspection is an activity that can be used to ensure that configuration and deployment problems are discovered before the application is in production. When an application is deployed, it is particularly important to be sure that weak or inappropriate configuration settings do not introduce security vulnerabilities.

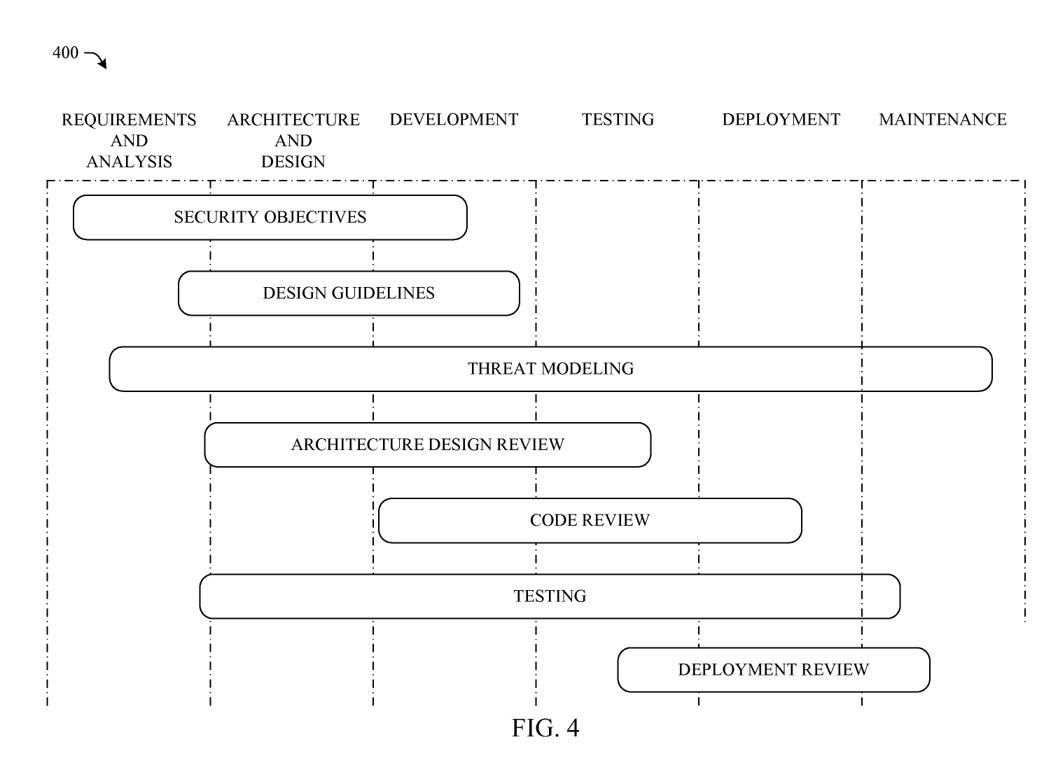

FIG. 4 illustrates a graph 400 that explains how the security activities 302 of FIG. 3 work together. As shown, security-related activities 302 start early and continue throughout the application life cycle, many in parallel with one another. FIG. 4 depicts how the security activities 302 span the various activities of the application development life cycle.

As illustrated by the overlap in FIG. 4, the innovation allows the results of each activity to influence the others in order to have a security engineering process that is more effective than the sum of its parts. By way of example, security objectives should be considered alongside other critical business objectives. Application specific security objectives should be identified and documented early during requirements and analysis and should be balanced along side other quality of service requirements such as performance, availability and reliability. Moreover, using security design guidelines can mitigate many threats found during the threat modeling process.

Threat modeling allows identification of threats and vulnerabilities. As illustrated by the overlap, the identified vulnerabilities and subsequent mitigations should be used to shape and influence subsequent design, development, and testing decisions. Further, issues found during code inspection and testing may result in new threats added to the threat model which in turn will drive new ideas for testing and code inspection.

It is to be understood that it is possible to incrementally adopt the key security activities in retrospect. The activities that should be adopted first will depend on the security objectives identified, as well as any outstanding problems of the process or application. For most organizations, particularly good results will come from adopting the activities in the following order:
Security Objectives. If the security objectives for an application are not known, it will be difficult to be successful with any other activity.
Security Design Inspection. Bugs introduced in the design phase are the most expensive to deal with later. By introducing architecture and design inspections focused on security, the user can avoid the need for costly rework later in the life cycle.
Threat Modeling. By adopting threat modeling, in addition to helping focus security development efforts, improving the overall quality of software engineering, and ensuring that the user addresses relevant threats, the user can help test teams create plans to test for specific vulnerabilities. Threat models also serve as a focus for communication among the various roles and help to ensure that developers and IT professionals alike really understand the application.
Security Code Inspection. While design bugs are the most expensive, implementation bugs are the most common. Inspecting code for security vulnerabilities can save later rework or help avoid costly exploits.
Security Deployment Inspection. Ant application is only as secure as its weakest link. Even a highly effective process can be undone by a configuration error during deployment.
Design Guidelines for Security. By adopting proven design principles and learning from others mistakes the user can ensure the application is secure from the start.
Security Testing. Testing should be used to validate designed mitigations and ensure nothing has slipped through the cracks.

The patterns & practices approach to security engineering focuses on integrating security into the application development life cycle through the adoption of a limited set of key security activities. It uses a pattern-based information model in the form of a set of vulnerability categories to help systematically focus efforts on areas where mistakes are most often made. The most common specific activities that make up the security engineering discipline include defining security objectives, applying design guidelines for security, creating threat models, conducting architecture and design inspections for security, completing code inspections for security, and performing deployment inspections for security.

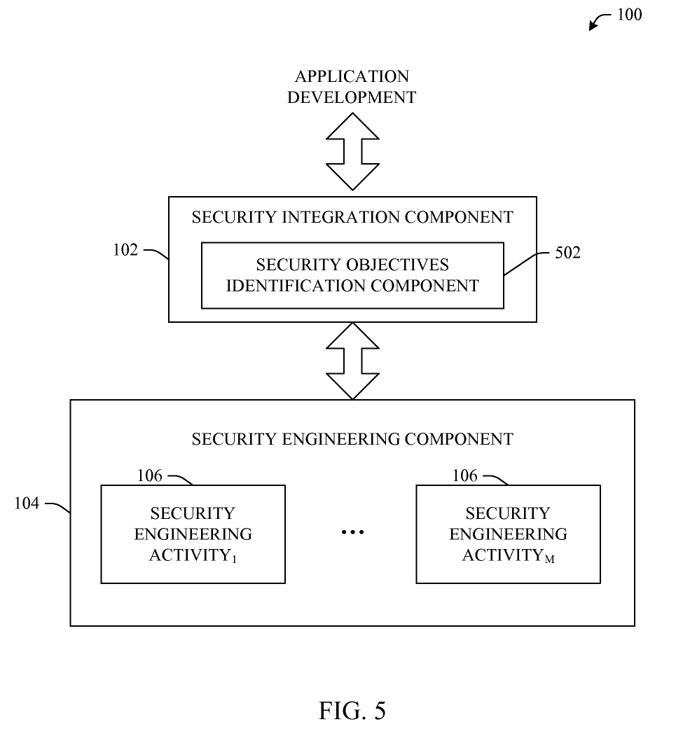

Turning now to FIG. 5, an alternative block diagram of system 100 is shown in accordance with an aspect of the innovation. Particularly, security integration component 102 can include a security objective identification component 502. Security objectives and requirements should be defined early in the application development process. Security objectives are goals and constraints that affect the confidentiality, integrity, and availability of the data and application.

Security objectives should ideally be identified in the requirements and analysis phase. If the objectives for the application are not known, then it is difficult to be successful with any other security activity. Generally, security objectives are used to:
Filter the set of design guidelines that are applicable;
Guide threat modeling activities;
Determine the scope and guide the process of architecture and design inspections;
Help set code inspection objectives;
Guide security test planning and execution; and
Guide deployment inspections.

In each activity, the security objectives can be used to help focus on the highest value areas while avoiding issues that will not affect the application.

Identifying security objectives is an iterative process that is initially driven by an examination of the application's requirements and usage scenarios. By the end of the requirements and analysis phase, the user should have a first set of objectives that are not yet tied to design or implementation details. During the design phase, additional objectives will surface that are specific to the application architecture and design. During the implementation phase, the user may discover a few additional objectives based upon specific technology or implementation choices that have an impact on overall application security. Each evolution of the security objectives can affect other security activities. The user should review the threat model, architecture and design review guidelines, and general code review guidelines when the security objectives change.

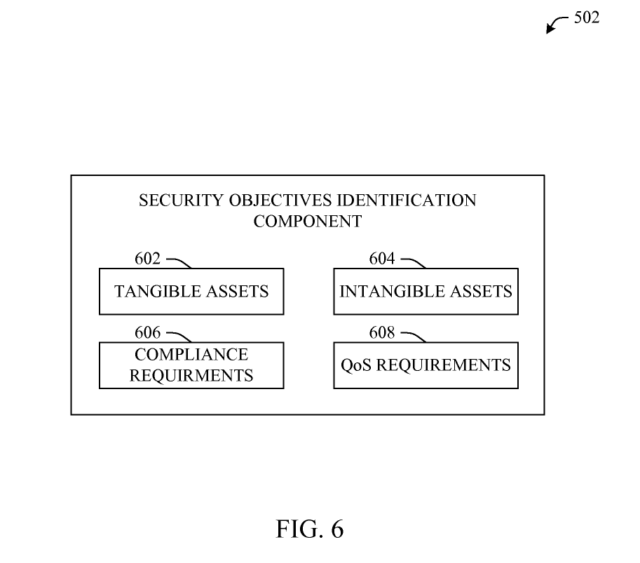

FIG. 6 illustrates a block diagram of an exemplary security objectives identification component. Although security objectives are unique for each application, there is a set of common categories of objectives that can be used to initiate the identification process. Each of these categories is associated with a set of questions that can be used to build an objective list. FIG. 6 illustrates exemplary security objective categories 602-608. As well, the following table illustrates the exemplary security objective categories 602-608 and associated questions that address potential pitfalls with respect to each category.

| | |
|---|---|
| Tangible assets to | Are there user accounts and passwords to protect? |
| protect - 602 | Is there confidential user information (such as credit |
| | card numbers) that needs to be protected? |
| | Is there sensitive intellectual property that needs to be |
| | protected? |
| | Can this system be used as a conduit to access other |
| | corporate assets that need to be protected? |
| Intangible assets | Are there corporate values that could be compromised |
| to protect - 604 | by an attack on this system? |
| | Is there potential for an attack that may be |
| | embarrassing, although not otherwise damaging? |
| Compliance | Are there corporate security policies that must be |
| requirements - | adhered to? |
| 606 | Is there security legislation you must comply with? |
| | Is there privacy legislation you must comply with? |
| | Are there standards you must adhere to? |
| | Are there constraints forced upon you by the |
| | deployment environment? |
| Quality of Service | Are there specific availability requirements you must |
| Requirements - | meet? |
| 608 | Are there specific performance requirements you must |
| | meet? |

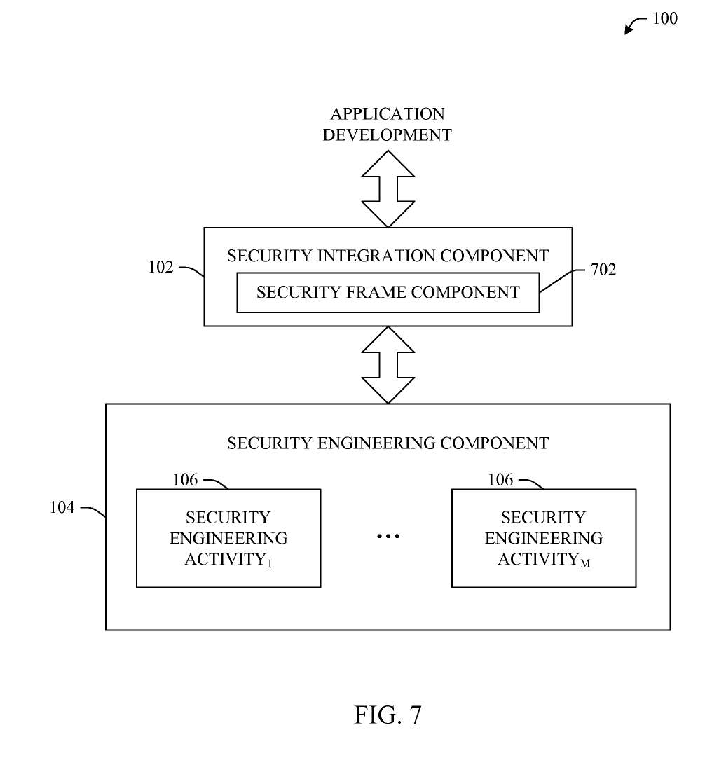

FIG. 7 illustrates an alternative block diagram of system 100 that addresses security design guidelines in accordance with an aspect of the innovation. Design guidelines can represent proven practices that have evolved over time to reduce risks associated with designing applications. Adopting security design guidelines can help reduce attack surface by addressing common vulnerabilities, allowing focus on the unique aspects of the design.

Designing a secure application can present architects and developers with many challenges. Design guidelines represent the set of practices that can be employed to reduce the risk of security vulnerabilities. Each guideline should meet the following qualifications before it is included:
Actionable. The guideline must be associated with a vulnerability that can be mitigated through the use of the guideline.
Relevant. The guideline must be associated with a vulnerability that is known to affect real applications.
Impactful. The guideline must represent key engineering decisions that will have a wide-ranging impact.

As illustrated in FIG. 7, the set of guidelines can be distilled into a pattern-based security frame 702, or framework, that describes all of the areas in which poor design can lead to security vulnerabilities. The security frame 702 can allow the inclusion of additional guidelines or the refinement of existing guidelines based on newly discovered vulnerabilities. It is to be understood that design guidelines include both deployment considerations and design considerations.

The security frame 702 is a pattern-based information model that defines a set of security-related categories specifically for the application type being designed. These categories can represent areas where security mistakes are most often made. Patterns & practices security guidance includes context-specific security frames (e.g., 702) for each major application type (e.g., web application).

Design guidelines are organized by the common application vulnerability categories contained in the security frame 702. For example, the categories can include, but are not limited to, input/data validation, authentication, authorization, configuration management, sensitive data, cryptography, exception management and auditing and logging. These categories represent particularly key areas for application security design, where mistakes are most often made.

The following table illustrates a set of vulnerability categories that is common to most application types. Also listed in the table are associated potential problems that can occur due to bad design.

| Vulnerability | |
|---|---|
| Category | Potential Problem Due to Bad Design |
| Input/Data | Insertion of malicious strings in user interface elements |
| Validation | or public application program interfaces (APIs). These |
| | attacks can include command execution, cross-site |
| | scripting (XSS), SQL injection, and buffer overflow. |
| | Results can range from information disclosure to |
| | elevation of privilege and arbitrary code execution. |
| Authentication | Identity spoofing, password cracking, elevation of |
| | privileges, and unauthorized access. |
| Authorization | Access to confidential or restricted data, data tampering, |
| | and execution of unauthorized operations. |
| Configuration | Unauthorized access to administration interfaces, ability |
| Management | to update configuration data, and unauthorized access to |
| | user accounts and account profiles. |
| Sensitive Data | Confidential information disclosure and data tampering. |
| Cryptography | Access to confidential data or account credentials, or |
| | both. |
| Exception | Denial of service and disclosure of sensitive system- |
| Management | level details. |
| Auditing and | Failure to spot the signs of intrusion, inability to prove a |
| Logging | user's actions, and difficulties in problem diagnosis. |

During the application design phase, the user should review corporate security policies and procedures together with the infrastructure associated with deployment of the application. Frequently, the target environment is rigid, and application design must reflect the restrictions. In some cases, design tradeoffs can be made, for example, because of protocol or port restrictions or specific deployment topologies. It is particularly important to identify constraints early in the design phase to avoid surprises later. As well, it is particularly important to involve members of the network and infrastructure teams to help with this process.

Design guidelines are best practices associated with specific known vulnerabilities and common design mistakes. Patterns & practices security guidance includes design guidelines for a variety of application types. The following table summarizes general design guidelines that are common to most application types.

| Category | Guideline |
|---|---|
| Input/Data | Do not trust input; consider centralized input |
| Validation | validation. |
| | Do not rely on client-side validation. |
| | Be careful with canonicalization issues. |
| | Constrain, reject, and sanitize input. |
| | Validate for type, length, format, and range. |
| Authentication | Use strong passwords. |
| | Support password expiration periods and account |
| | disablement. Do not store credentials (use one-way |
| | hashes with salt). |
| | Encrypt communication channels to protect |
| | authentication tokens. |
| Authorization | Use least privileged accounts. |
| | Consider authorization granularity. |
| | Enforce separation of privileges. |
| | Restrict user access to system-level resources. |
| Configuration | Use least privileged process and service accounts. |
| Management | Do not store credentials in clear text. |
| | Use strong authentication and authorization on |
| | administration interfaces. |
| | Do not use the Local Security Authority (LSA). |
| | Secure the communication channel for remote |
| | administration. |
| Sensitive Data | Avoid storing secrets. |
| | Encrypt sensitive data over the wire. |
| | Secure the communication channel. |
| | Provide strong access controls for sensitive data |
| | stores. |
| Cryptography | Do not develop your own. |
| | Use proven and tested platform features. |
| | Keep unencrypted data close to the algorithm. |
| | Use the right algorithm and key size. |
| | Avoid key management (use DPAPI). |
| | Cycle keys periodically. |
| | Store keys in a restricted location. |
| Exception | Use structured exception handling. |
| Management | Do not reveal sensitive application implementation |
| | details. |
| | Do not log private data such as passwords. |
| | Consider a centralized exception management |
| | framework. |
| Auditing and | Identify malicious behavior. |
| Logging | Know what good traffic looks like. |
| | Audit and log activity through all of the application |
| | tiers. |
| | Secure access to log files. |
| | Back up and regularly analyze log files. |

Design guidelines can be used as a tool to assist in meeting application security objectives. The security frame 702 provides a structure within which guidelines can be modified or added knowledge about the application's architecture and deployment environment is obtained. Patterns & practices security guidance includes a core set of guidelines, organized by application type that can be used as a starting point for the application's guidelines. Each guideline should be actionable, impactful, and relevant. Additionally, guidelines should be organized into the categories contained in the security frame 702.

Turning now to a discussion of threat modeling, threat modeling is an engineering technique that can be employed to assist in identifying threats, attacks, vulnerabilities, and countermeasures that may be relevant to an application. More particularly, the threat modeling activity helps to recognize the following: security objective, relevant threats, and relevant vulnerabilities and countermeasures.

Threat modeling can be performed to identify when and where more resources are required (or justified) to reduce risks. There are many possible vulnerabilities, threats, and attacks, and it is unlikely that the application will encounter all of them. Threat modeling helps to identify where an organization should apply effort.

In general, threat modeling helps to:
Shape application design to meet security objectives;
Help make engineering decisions that weigh security goals against other design goals;
Address and improve the quality of the engineering efforts by eliminating common vulnerabilities;
Improve quality of service by implementing necessary and effective countermeasures; and
Reduce risk of security issues arising during development and operations.

Threat modeling begins early in the architecture and design phase of the application life cycle. It is performed with knowledge of security objectives. As described above, security objectives are a key part of business objectives and are used to determine the extent of the threat modeling activity and where to spend the most effort.

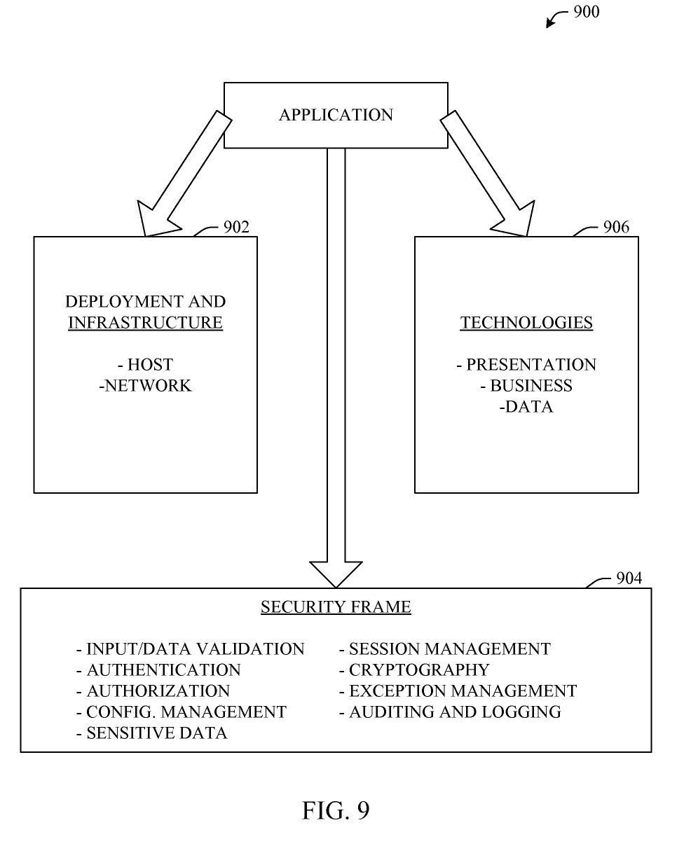

As the life cycle progresses and design and development evolve, more detail can be progressively added to the threat model. As illustrated in FIG. 9, the threat modeling process is iterative. The process should be repeated as indicated by the following:
Increase the detail of the model whenever new environmental facts become known;
Increase the detail of the model as design and implementation decisions reveal new facts; and
Add detail as new uses and configurations of the application appear. This is during the application lifetime including after the application is in production and is maintained by the operations team.

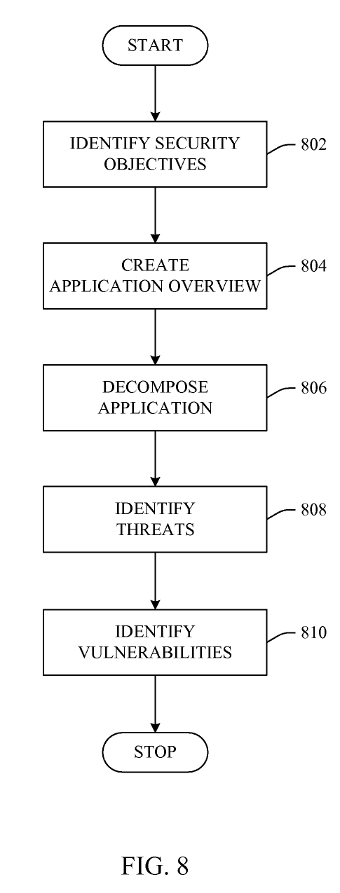

FIG. 8 illustrates an activity overview methodology of the threat modeling activity in accordance with an aspect of the innovation. Generally, five major threat modeling acts are shown in FIG. 8.

At 802, security objectives are identified. As described supra, clear objectives help to focus the threat modeling activity and determine how much effort to spend on subsequent steps. An application overview is generated at 804. It will be understood that itemizing the application's important characteristics and actors helps to identify relevant threats later in the methodology.

The application can be decomposed at 806. In accordance with this act, a detailed understanding of the mechanics of the application makes it easier to uncover more relevant and more detailed threats. At 808, details from the application overview (804) and the application decomposition (806) can be used to identify threats relevant to the application scenario and context. Finally, vulnerabilities are identified at 810. In this acts review of the layers of the application can be used to identify weaknesses in the context of threats. Moreover, vulnerability categories can be used to help to focus on those areas where mistakes are most often made.

As shown, it is possible to progressively refine the threat model by repeatedly performing acts 804-810. Additional detail can be added when traversing through the application development life cycle and discover more about the application design.

The following table summarizes the methodology of FIG. 8. More particularly, the table identifies the input and output with respect to each act of FIG. 8.

| Input | Step | Output |
|---|---|---|
| Business requirements | 802: Identify security | Key security |
| Security policies | objectives | objectives |
| Compliance | | |
| requirements | | |
| Deployment diagrams | 804: Create an | Whiteboard-style |
| Use cases | application overview | diagram with |
| Functional | | end-to-end |
| specifications | | deployment |
| | | scenario |
| | | Key scenarios |
| | | Roles |
| | | Technologies |
| | | Application security |
| | | mechanisms |
| Deployment diagrams | 806: Decompose the | Trust boundaries |
| Use cases | application | Entry points |
| Functional | | Exit points |
| specifications | | |
| Data flow diagrams | | |
| Common Threats | | |
| Common Vulnerabilities | | |
| Common threats | 808: Identify threats | Threat list |
| Common vulnerabilities | 810: Identify | Vulnerability list |
| | vulnerabilities | |

The table below represents novel expertise and actions that can be employed in accordance with the threat modeling approach to identify vulnerabilities in an application. These concepts leverage expertise into the novel innovative techniques described herein.

| Concept | Description |
|---|---|
| Modeling to | Use threat modeling to identify when and where you |
| reduce risk | should apply effort to eliminate or reduce a potential |
| | threat. Avoid wasted effort by threat modeling to clarify |
| | the areas of most risk. |
| Incremental | Perform threat modeling iteratively. You should not be |
| rendering | too concerned about missing details in any single |
| | iteration —instead focus on making each iteration |
| | productive. |
| Context | Understand application use cases and roles in order to |
| precision | identify threats and vulnerabilities that are specific to the |
| | application. Different application types, application |
| | usage, and roles can yield different threats and |
| | vulnerabilities. |
| Boundaries | Establish boundaries in order to help you define |
| | constraints and goals. Boundaries help you identify what |
| | must not be allowed to happen, what can happen, and |
| | what must happen. |
| Entry and exit | Define entry and exit criteria to establish tests for |
| criteria | success. You should know before you start what the |
| | threat model will look like when complete (good enough) |
| | and when you have spent the right amount of time on the |
| | activity. |
| Communi- | Use the threat model as a communication and |
| cation and | collaboration tool. Leverage discovered threats and |
| collaboration | vulnerabilities to improve shared knowledge and |
| tool | understanding. |
| Pattern-based | Use a pattern-based information model to identify the |
| information | patterns of repeatable problems and solutions, and |
| model | organize them into categories. |
| Primary | Expose the high-risk engineering decisions and design |
| engineering | choices with the threat model. These high-risk choices |
| decisions | are good candidates for focusing prototyping efforts. |

In summary, threat modeling is a structured activity for identifying and evaluating application threats and vulnerabilities. As such, the threat modeling activity should be started early in the architecture and design phase of the application life cycle. The threat model can be continually updated and refined as more information about the design and implementation is learned. Threat modeling can be used to shape application design to meet security objectives, to help weigh the security threat against other design concerns (such as performance) when making key engineering decisions, and to reduce the risk of security issues arising during development and operations.

Turning now to a discussion of a security design inspection activity, FIG. 9 illustrates an exemplary application inspection process 900 in accordance with an aspect of the innovation. There are at least three important aspects to conducting an architecture and design inspection for security. First, it is particularly important to evaluate the application architecture in relation to its target deployment environment and infrastructure. Second, design choices in each of the key vulnerability categories defined by a security frame should be reviewed. Finally, a tier-by-tier component analysis should be conducted and the security mechanisms employed by the key components should be examined such as presentation layer, business layers and data access layer

The security design inspection activity process analyzes application architecture and design from a security perspective. This activity can be employed to expose the high-risk design decisions that have been made. It is particularly important not to rely solely on the use of design documentation as some design decisions will not be explicit but will have to be discovered through dialog and exploration. A combination of design documents, architecture experts and discussion can be used to achieve the enhanced results. One goal of the inspection is to decompose the application and identify key items, including trust boundaries, data flow, entry points, and privileged code. It is important to keep in mind the physical deployment configuration of the application.

The areas defined by the security frame of the application is where many commonly vulnerabilities can be found. The novel innovation contemplates context-specific security frames for each major application types. A question-driven approach can be used to expose the highest risk design decisions while the security frame can be used to expose areas that reveal common mistakes. The application review techniques illustrated in FIG. 9 can assist in guiding the approach when inspecting the architecture and design of the application. A deployment and infrastructure technique is illustrated at 902. In accordance with this technique, a user can review the design of the application in relation to the target deployment environment and the associated security policies. It is helpful to consider the restrictions imposed by the underlying infrastructure layer security.

The use of the security frame is illustrated by 904. The security frame enables review of the approach to critical areas in the application, including, but not limited to, authentication, authorization, input/data validation, exception management, and other areas. The application vulnerability categories can be used as a roadmap and to make sure that any key areas are not overlooked during the review. Finally, at 906, a tier-by-tier analysis is shown. In this technique, a user can walk through the logical tiers of the application, and evaluate security choices within the presentation, business, and data access layers.

In accordance with each of the activities described herein, checklists can be employed to assist in performing the activity. For example, a checklist can be used to assist in performing security design inspections while evaluating the security of the applications. The checklist can assist in exploring the high-level design and architecture decisions that have been made for the application

As will be appreciated if more time and effort is spent at the beginning of the project to analyze and review application architecture and design, design-related sooner abilities can be reduced or eliminated) and the applications overall security can be improved. It is much easier and less expensive to fix vulnerabilities at design time than it is later in the development cycle when substantial re-engineering might be required.

Security design inspections can be employed iteratively as the design evolves or as more is learned about the design and architecture of the applications. If the application has already been created, the architecture and design inspection is still an important part of the security assessment process that can help to address and/or fix vulnerabilities and improve future designs.

Security code inspection is an effective mechanism for uncovering security issues before testing or deployment begins. Performing code inspections helps reduce the number of implementation errors in an application before it is deployed to a test team or to a customer. While design bugs are the most expensive to fix, implementation bugs are frequently the most common.

A properly conducted code inspection can do more for the security of the code than nearly any other activity. A large numbers of bugs can be found and fixed before the code makes it into an official build or into the hands of the test team. Additionally, the code inspection process lends itself very well to sharing security best practices among a development team, and it produces lessons that can be learned from to prevent future bugs.

To have an effective code inspection, it is important to first understand the patterns of bad code that should be eradicated, and then review the code with a clear idea of what is desired. Security objectives can be used to guide the code inspection process. Some vulnerability types may have elevated priority and others may be out of bounds based upon these objectives. Threat models can be used to create a more focused code inspection. Reviewing for specific known threats is more likely to result in bugs than a generic review that could be applied to any application.

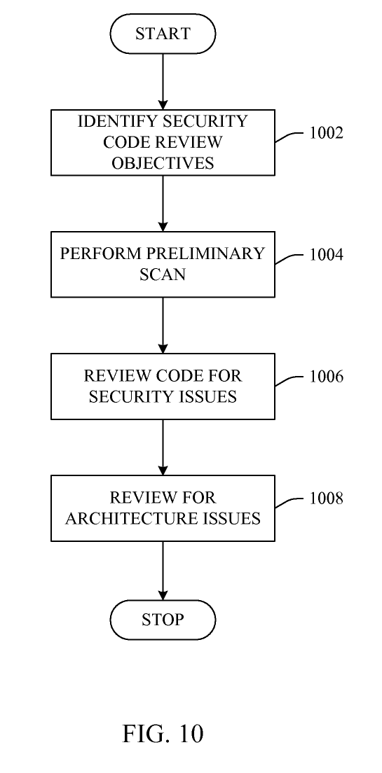

Four exemplary code inspection acts are shown in FIG. 10. In operation, it is to be understood that each act can build upon the last thereby producing a result that is greater than the sum it its parts.

With reference to FIG. 10, at 1002, security code inspection objectives can be identified. In this act, goals and constraints can be established for a review. A preliminary scan can be performed at 1004. In one aspect, static analysis can be used to find an initial set of bugs and improve an understanding of where bugs are most likely to be discovered during further review.

The code can be reviewed with respect to security issues at 1006. Here, the code can be reviewed thoroughly to find security vulnerabilities that are common to many applications. As well, the results of the preliminary scan from 1004 can be used to focus the analysis. Finally, at 1008, a review for security issues that are unique to the application can be conducted. Effectively a final analysis can be conducted that focuses on bugs that relate to the unique architecture of the application. This act is most important if an implementation of a custom security mechanism or any feature designed specifically to mitigate a known security threat has been done.

With continued reference to the methodology of FIG. 10, the following table summarizes the security code inspection activity and shows an exemplary input and output for each act.

| Input | Act | Output |
|---|---|---|
| Security | 1002. Identify | Code review |
| Requirements | code review | objectives |
| Code (including | objectives | |
| list of changes | | |
| since last review) | | |
| Constraints | | |
| Code | 1004. Perform | Vulnerability list |
| Code review | preliminary scan | (false positives |
| objectives | | filtered out) |
| Code | 1006. Review code | Vulnerability list |
| Code review | for security issues | |
| objectives | | |
| List of flagged | | |
| areas | | |
| Code | 1008. Review code | Vulnerability list |
| Code review | for security issues | |
| objectives | unique to the | |
| | application | |
| | architecture | |

A code reviewer can make use of control flow and/or dataflow analysis techniques while reviewing code. These techniques are most effective when used in combination with each other. Control flow analysis is a mechanism used to step through logical conditions in the code. The control flow analysis process can be implemented as follows:

1. Look at a function and determine each branch condition. These can include loops, switch statements, if statements and try/catch blocks.

2. Understand the conditions under which each block will be executed.

3. Move to the next function and repeat.

Dataflow analysis refers to the mechanism used to trace data from the points of input to the points of output. Because there can be many data flows in an application, code review objectives and the flagged areas from step 2 below can be used to focus efforts. The process works as follows:

1. For each input location, determine how much you trust the source of input. When in doubt you should give it no trust.

2. Trace the flow of data to each possible output, noting along the way any attempts at data validation.

3. Move to the next input and continue.

A question-driven approach can help with the review process. The innovation contemplates question lists for each major application type. These lists can each contain a set of questions that are known to be effective during code review. These questions can be applied while using control flow and dataflow analysis. As well, additional questions can be added as information is learned about reviewing code. It is to be understood that some vulnerabilities require contextual knowledge of control and data flow while others are context free and can be found with simple pattern matching.

Each of the questions can be organized into a set of “hotspots” or trouble areas that are based on implementation mistakes that most commonly result in application vulnerabilities. The following table illustrates example hotspots.

| Hotspot | What to look for in code |
|---|---|
| SQL Injection | A SQL injection attack occurs when un-trusted input can |
| | modify the logic of a SQL query in unexpected ways. As |
| | you are work through the code, ensure that any input that is |
| | used in a SQL query is validated, or make sure that the SQL queries |
| | are parameterized. |
| Cross Site | Cross-site scripting occurs when an attacker manages to |
| Scripting | input script code into an application so that it is echoed back |
| | and executed in the security context of the application. This |
| | allows an attacker to steal user information, including forms |
| | data and cookies. This vulnerability could be present |
| | whenever a Web application echoes unfiltered user input back to Web |
| | content. |
| Data Access | Look for improper storage of database connection strings |
| | and proper use of authentication to the database. |
| Input/Data | Look for client-side validation that is not backed by server- |
| Validation | side validation, poor validation techniques, and reliance on |
| | file names or other insecure mechanisms to make security |
| | decisions. |
| Authentication | Look for weak passwords, clear-text credentials overlong |
| | sessions, and other common authentication problems. |
| Authorization | Look for failure to limit database access, inadequate |
| | separation of privileges, and other common authorization |
| | problems. |
| Sensitive data | Look for mismanagement of sensitive data disclosing |
| | secrets in error messages, code, memory, files, or network. |
| Unsafe code | Pay particularly close attention to any code compiled with |
| | the /unsafe switch. This code will not be given all of the |
| | protection normal managed code is given. Look for |
| | potential buffer overflows, array out of bound errors, integer |
| | underflow and overflow, as well as data truncation errors. |
| Unmanaged code | In addition to the checks performed for unsafe code, also |
| | scan unmanaged code looking for the use of dangerous |
| | APIs, such as strcpy and strcat. Be sure to review any |
| | interop calls and the unmanaged code itself to make sure |
| | that bad assumptions are not made as execution control |
| | passes from managed to unmanaged code. |
| Hard-coded | Look for hard-coded secrets by examining the code for |
| secrets | variable names such as “key”, “password”, “pwd”, “secret”, |
| | “hash”, and “salt”. |
| Poor error | Look for functions with missing error handlers or empty |
| handling | catch blocks. |
| Web.config | Examine the configuration management settings in the |
| | Web.config file to ensure that forms authentication tickets |
| | are protected adequately, that the correct algorithms are |
| | specified on the machineKey element and so on. |
| Code access | Search for the use of asserts, link demands and |
| security | allowPartiallyTrustedCallersAttribute (APTCA). |
| Code that uses | Check for failure to clear secrets as well as improper use of |
| cryptography | the cryptography APIs themselves. |
| Undocumented | Most undocumented interfaces should not be in the product, |
| public interfaces | and they are almost never given the same level of design |
| | and test scrutiny as the rest of the product. |
| Threading | Check for race conditions and deadlocks, especially in static |
| problems | methods and constructors. |
| Unmanaged code | In addition to the checks performed for unsafe code, also |
| | scan unmanaged code looking for the use of dangerous |
| | APIs, such as strcpy and strcat. Be sure to review any |
| | interop calls and the unmanaged code itself to make sure |
| | that bad assumptions are not made as execution control |
| | passes from managed to unmanaged code. |
| Hard-coded | Look for hard-coded secrets by examining the code for |
| secrets | variable names such as “key”, “password”, “pwd”, “secret”, |
| | “hash”, and “salt”. |

Turning now to a discussion of code inspection scenarios, there are several strategies for conducting code inspections, including, but not limited to individual and team inspections. The individual inspection strategy assumes that a single person will review the code. On the other hands a team inspection strategy assumes that multiple people will review the sane code. Each can be a highly effective code inspection strategy, however, team inspection requires additional organization to be successful.

In either strategy, a reviewer who is familiar or unfamiliar with the code can be selected. One advantage of using a reviewer who does not have prior knowledge of the code is that they will examine the code with fresh eyes and will be less likely to make assumptions than someone who is more familiar might make. One advantage of using a reviewer with knowledge of the code is that they will be able to find subtle errors that require expert familiarity with the application under review.

During a code inspection, there can be several distinct tasks:
Present the objectives. Describe the application/component purpose and security objectives;
Present the code. Walk through the code and describe its design and intent;
Review the code. Review the code aid find, bugs; and
Take notes. Take notes that describe the bugs found, any open questions and areas for future investigation

Security code inspections are a powerful tool to reduce the number of vulnerabilities in an application. Through the use of control flow and dataflow analysis in conjunction with a question list, it is possible to find and fix implementation bugs before they are delivered to the test team or customer. The lessons learned in code inspection can be used to update the question list and spread secure development best practices through the development team.

A security deployment inspection is an activity that can be used to ensure that configuration and deployment problems are discovered before they can result in an application vulnerability. Even the most securely designed and implemented application can be compromised by an error during deployment, leaving it open to attack. Application security is dependent upon the security of the underlying infrastructure on which the application is deployed. The deployment inspection, depending upon the application, can cover configuration of both the network and the host.

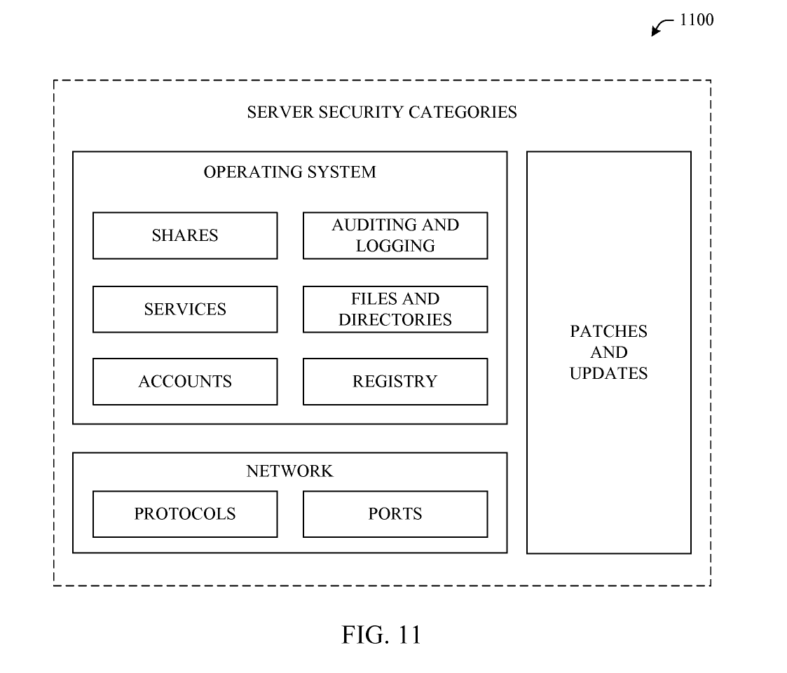

Upon reviewing security deployment, it can be helpful to organize the precautions and the settings into categories. An exemplary list 1100 of these categories is shown in FIG. 11. By using these configuration categories, it is possible to systematically review the entire application, or pick a particular category and complete specific steps.

The novel security guidance of the innovation includes server security categories for each major application type. These categories can be used as a starting point in the deployment inspection. As wells new items can be added as they are discovered and more is learned about deployment inspections. The following table lists categories that are common to most deployed applications.

| Category | Practices |
|---|---|
| Patches and | Patching and updating the server software is a critical first |
| Updates | step. |
| Accounts | Accounts allow authenticated users to access a computer. |
| | These accounts must be audited. Configure accounts with |
| | least privilege to help prevent elevation of privilege. |
| | Remove any accounts that you do not need. Help to prevent |
| | brute force and dictionary attacks by using strong password |
| | policies, and then use auditing and alerts to detect logon |
| | failures. |
| Auditing and | Auditing is one of the most important tools for identifying |
| Logging | intruders, attacks in progress, and evidence of attacks that |
| | have occurred. Configure auditing for the server. Event and |
| | system logs also help you to troubleshoot |
| | security problems. |
| Files and | Secure all files and directories with restricted permissions |
| Directories | that only allow access to necessary services and accounts. |
| | Use auditing to allow you to detect when suspicious or |
| | unauthorized activity occurs. |
| Ports | Services that run on the server listen to specific ports so that |
| | they can respond to incoming requests. Audit the ports on |
| | the server regularly to ensure that a service that is not |
| | secured or that is unnecessary is not active on the server. |
| Protocols | Avoid using protocols that are inherently insecure. If you |
| | cannot avoid using these protocols, take the appropriate |
| | measures to provide secure authentication and |
| | communication. |
| Registry | Many security-related settings are stored in the registry. As |
| | a result, you must secure the registry. You can do this by |
| | applying restricted Windows access control lists (ACLs) |
| | and by blocking remote registry administration. |
| Services | If the service is necessary, secure and maintain the service. |
| | Consider monitoring any service to ensure availability. If |
| | the service software is not secure, but you need the service, |
| | try to find a secure alternative. |
| Shares | Remove all unnecessary file shares. Secure any remaining |
| | shares with restricted permissions. |

Deployment inspections can help to ensure that application security is not compromised by poor configuration of the network or host. By using server security categories, a systematic review that can be effectively repeated during the next deployment can be conducted.

In still another aspect, a machine learning and reasoning (MLR) component (e.g., artificial intelligence (AI) component) can be included which facilitates automating one or more features in accordance with the subject innovation. The subject innovation (e.g., in connection with identification of security objectives) can employ various MLR-based schemes for carrying out various aspects thereof. For example, a process for determining an appropriate set of objectives can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria specific security objectives, which security engineering activities to employ, identification and execution with respect to criteria associated with activities, etc.

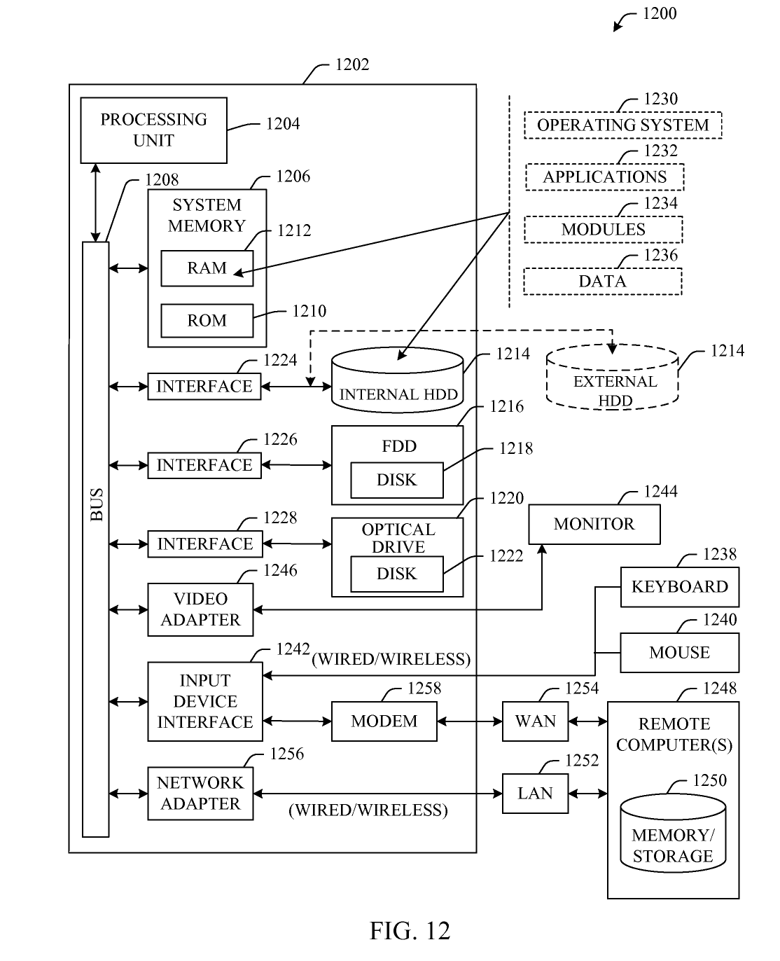

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1130 is illustrated. The logical connections depicted include wired/wireless connectivity to a local area network (LAN) 1132 and/or larger networks, e.g., a wide area network (WAN) 1134. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1132 through a wired and/or wireless communication network interface or adapter 1136. The adapter 1136 may facilitate wired or wireless communication to the LAN 1132, which may also include a wireless access point disposed thereon for communicating with the wireless adapter 1136.

When used in a WAN networking environment, the computer 1202 can include a modem 1138, or is connected to a communications server on the WAN 1134, or has other means for establishing communications over the WAN 1134, such as by way of the Internet. The modem 1138, which can be internal or external and a wired or wireless device, is connected to the system bus 1208 via the serial port interface 1242. In a networked environment, program modules depicted relative to the computer 1202, or portions thereof, can be stored in the remote memory/storage device 1130. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

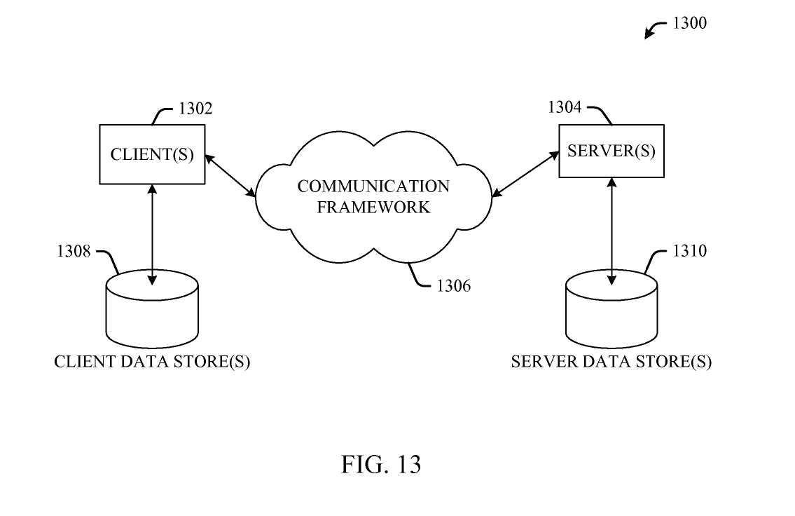

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates security engineering of an application, comprising:
a security engineering component that includes a plurality of security engineering activities; and
a security integration component that integrates a subset of the plurality of security engineering activities into development of the application.

2. The system of claim 1, the plurality of security engineering activities includes at least one of identifying security objectives, identifying threat models, applying secure design guidelines, conducting security design inspections, performing regular security code inspections, implementing security testing, and conducting security deployment inspections.

3. The system of claim 1, the security integration component integrates the subset of the plurality of security engineering activities based upon a phase of the development of the application.

4. The system of claim 3, the subset of the plurality of security engineering activities includes a security objectives identification activity and the phase is a requirements and analysis phase.

5. The system of claim 3, the subset of the plurality of security engineering activities includes at least one of a security design guidelines activity, a threat modeling activity and a security architecture and design inspection activity and the phase is an architecture and design phase.

6. The system of claim 3, the subset of the plurality of security engineering activities includes a security code inspection activity and the phase is a development phase.

7. The system of claim 3, the subset of the plurality of security engineering activities includes a security testing activity and the phase is a testing phase.

8. The system of claim 3, the subset of the plurality of security engineering activities includes a security deployment inspection activity and the phase is a deployment phase.

9. The system of claim 1, the security integration component comprises a security objectives identification component that interfaces with a user to identify a plurality of security objectives.

10. The system of claim 9, the security objectives identification component includes at least one of a tangible asset, an intangible asset, a compliance requirement and a quality of service requirement.

11. The system of claim 9, the security objectives identification component comprises a security frame component that defines a set of security-related categories based upon a type of the application.

12. The system of claim 11, the set of security-related categories comprises at least one of shares, services, accounts, auditing and logging, files and directory registry, patches and updates, protocols and ports.

13. A computer-implemented method of engineering an application, comprising:
identifying a category;
identifying a security objective based at least in part upon the category; and
integrating a security engineering activity based at least in part upon the security objective.

14. The computer-implemented method of claim 13, further comprising establishing security design guidelines based at least in part upon the security objective.

15. The computer-implemented method of claim 13 further comprising reviewing the application from an architectural and design security perspective.

16. The computer-implemented method of claim 13, the act of identifying the security objective comprises:
identifying data to protect;
identifying compliance requirements;
identifying quality of service requirements; and
identifying intangible assets to protect.

17. The computer-implemented method of claim 13, further comprising identifying a threat based at least in part upon the objective.

18. The computer-implemented method of claim 17, the act of identifying the threat comprises:
identifying at least one of a common threat and an attack;
identifying the threat based at least in part upon a usage scenario; and
identifying the threat based at least in part upon a data flow of the application.

19. A computer-executable system that facilitates security engineering of an application, comprising:
means for identifying a usage scenario associated with the application;
means for identifying a security objective based at least in part upon the usage scenario; and
means for integrating security expertise into the application based at least in part upon the performance objective.

20. The computer-executable system of claim 19, the means for integrating a security objective comprises at least one of:
means for establishing security design guidelines;
means for threat modeling;
means for conducting a security design inspection;
means for testing security; and
means for conducting a security deployment inspection.
